(19) United States
(12) Patent Application Publication
(10) Pub. No.: US 2026/0348916 A1
(43) Pub. Date: Nov. 5, 2026

(54) FLEXIBLE PROBE CUSHION FOR NON-DESTRUCTIVE TEST

(71) Applicant: Evident Canada, Inc., Québec (CA)

(72) Inventors: Simon Y. Tessier, Québec (CA); Francois Houde, Québec (CA); David Joyce, Chelmsford, MA (US)

(21) Appl. No.: 19/486,684

(22) PCT Filed: Jun. 13, 2024
(86) PCT No.: PCT/CA2024/050802

§ 371 Date: Nov. 21, 2025

Related U.S. Application Data
(60) Provisional application No. 63/508,183, filed on Jun. 14, 2023.

(51) Int. Cl. G01N 27/9093; G01N 27/904

(52) U.S. Cl. CPC G01N 27/9093; G01N 27/904

(57) ABSTRACT

A non-destructive probe assembly, such as an eddy current array (ECA) sensor probe assembly, can include a flexible cushion. The flexible cushion can include or can support respective eddy current sensors, such as to facilitate inspection of an object under test having a curved surface. The flexible cushion can include one or more rib structures to allow deformation along a specified axis, and such rib structures can be arranged to suppress deformation along another axis. During inspection, the probe assembly can traverse a surface of the object under test including deforming a portion of flexible cushion of the ECA sensor assembly to maintain contact between an active surface of the ECA sensor assembly and the object under test. Such an approach can inhibit or suppress lift-off of the ECA sensor even when being used to inspect curved surfaces.

### CLAIM OF PRIORITY

This patent application claims the benefit of priority of Tessier et al., U.S. Provisional Patent Application No. 63/508,183, titled “FLEXIBLE PROBE CUSHION,” filed on Jun. 14, 2023 (Attorney Docket No. 6409.265PRV), which is hereby incorporated by reference herein in its entirety.

### FIELD OF THE DISCLOSURE

This document pertains generally, but not by way of limitation, to apparatus and techniques for non-destructive inspection such as facilitating eddy current inspection, and more particularly, to apparatus and techniques comprising a sensor assembly having a flexible cushion at an interface between the sensor assembly and an object under test.

### BACKGROUND

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, scratch, void, porosity, or other inhomogeneity (e.g., corrosion or pitting). Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure in response to such excitation, using either the same coil for both excitation and pickup (e.g., connected through a bridge circuit), or using one coil for transmission and another coil for pickup. Generally, eddy current inspection can be sensitive to variation in a distance between an EC sensor and the object under test, such as compromising sensitivity if the EC sensor is lifted away from a surface of an object under test.

### SUMMARY OF THE DISCLOSURE

A non-destructive inspection probe assembly, such as an eddy current array (ECA) sensor probe assembly, can include a flexible cushion. The flexible cushion can include or can support respective eddy current sensors, such as to facilitate inspection of an object under test having a curved or otherwise non-planar surface. The flexible cushion can include one or more rib structures to allow deformation along a specified axis, and such rib structures can be arranged to suppress deformation along or about another axis. During inspection, the probe assembly can traverse a surface of the object under test including deforming a portion of flexible cushion of the ECA sensor assembly to maintain contact between an active surface of the ECA sensor assembly and the object under test. Such an approach can inhibit or suppress lift-off of the ECA sensor even when being used to inspect curved surfaces.

Generally, the apparatus and techniques described herein can include a flexible cushion to provide a mechanically flexible interface between a non-destructive inspection probe sensor, such as an ECA sensor, and an object under test. The mechanically flexible interface can be configured (e.g., using materials or features such as one or more internal rib structures) to provide flexibility or cushioning. The mechanically flexible interface can be configured to resist or even entirely inhibit flexure or rotation along specified axes. Features that modulate compliance, such as rib structures can be included such as within a flexible cushion supporting a sensor assembly. Such structures need not be uniform in configuration or spacing, and variation in such configuration can provide a variable amount of compliance across a length or area of the probe assembly.

Cushioning can help the probe assembly to conform to curved surfaces of an object under test, without lift-off of the probe assembly, such as during translation or scanning of the probe assembly across the surface being inspected. Curved surfaces of objects under test can have convex or concave profiles, or compound curvature, such as including curvature in more than one axis. The flexible cushion configurations described herein can be fabricated using materials compatible with additive manufacturing processing, such as to facilitate three-dimensional printing of complex internal configurations. Such materials can include silicone or thermoplastic elastomer materials (e.g., abbreviated “TPx” or “TPE”) such as thermoplastic polyurethane (TPU), or thermoplastic polyamide (TPA), as illustrative examples.

In an example, a non-destructive inspection probe assembly can include a housing, a flexible cushion coupled to the housing, and a flexible sensor assembly anchored to the flexible cushion. The flexible cushion can comprise a structure that resists deformation of the flexible cushion in a first degree of freedom relative to an orthogonal second degree of freedom. For example, the flexible cushion can permit deformation in a Z direction that is orthogonal to a plane defining an active surface of the flexible cushion. In an example, the structure that resists deformation comprises at least one rib structure extending between interior-facing surfaces of the flexible cushion.

In an example, a method for fabrication of at least a portion non-destructive inspection probe can include additively manufacturing a flexible cushion. This fabrication can include additively (or otherwise forming) features to anchor the flexible cushion to a housing, and additively manufacturing (or otherwise forming) at least one rib structure that resists deformation of the flexible cushion in a first degree of freedom relative to an orthogonal second degree of freedom. A flexible sensor assembly can be installed in a region of the flexible cushion to orient an active surface of the flexible sensor outward from a surface of the flexible cushion.

In an example, a flexible cushion can be provided for use with a non-destructive inspection probe, the flexible cushion comprising a flexible polymer material defining at least one rib structure that resists deformation of the flexible cushion in a first degree of freedom relative to an orthogonal second degree of freedom and a region for installation of a flexible sensor assembly to orient an active surface of the flexible sensor outward from a surface of the flexible cushion. For example, the at least one rib structure can extend between interior-facing surfaces of the flexible cushion.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a non-destructive inspection system, such as can be used to perform at least a portion one or more techniques as shown and described herein.

FIG. 2 is a diagram illustrating an exploded view of a non-destructive inspection probe assembly comprising various elements, including a flexible cushion and a flexible sensor assembly.

FIG. 3A illustrates generally an example comprising a flexible cushion.

FIG. 3B illustrates a cut-away view of the flexible cushion of FIG. 3A.

FIG. 3C and FIG. 3D illustrate respective examples of side views of non-uniform compression of the flexible cushion.

FIG. 4A is a diagram illustrating an exploded view of a flexible cushion and a flexible sensor assembly that can form a portion of a non-destructive inspection probe assembly.

FIG. 4B illustrates a cut-away view of the flexible cushion of FIG. 4A.

FIG. 4C illustrates a side cut-away view of a non-destructive inspection probe assembly that can include the flexible cushion and flexible sensor assembly shown in FIG. 4A.

FIG. 4D illustrates an isometric cut-away view of a non-destructive inspection probe assembly that can include the flexible cushion and flexible sensor assembly shown in FIG. 4A.

FIG. 5A illustrates generally another example comprising an isometric cut-away view of a flexible cushion that can have a non-uniform compliance along at least one axis.

FIG. 5B illustrates generally yet another example comprising an isometric view of a flexible cushion that can have a non-uniform compliance along at least one axis.

FIG. 6A, FIG. 6B, and FIG. 6C illustrate different views of yet another example comprising a flexible cushion, having inner and outer rib arrangements.

FIG. 7 illustrates generally a technique, such as a method of fabrication, to provide a flexible cushion, such as associated with an inspection probe assembly.

### DETAILED DESCRIPTION

Non-destructive inspection can be performed using a probe assembly, such as a hand-held probe that can include a housing, interconnections, electronic circuitry, and a sensor (or array of sensors). For example, for eddy current array (ECA) inspection, a flexible printed circuit board can include respective eddy current sensor elements (e.g., planar inductive coils). The present inventors have recognized, among other things, that non-destructive inspection may be performed by scanning or translating a probe assembly along surfaces that are not perfectly flat, such as including either convex or concave surface topology (or both). Irregular surfaces can cause a sensor assembly to be lifted away from a surface of an object being inspected, such as hindering inspection (e.g., causing error due to lift-off or causing false flaw indications). In one approach, a solid foam pad can be used, such as upon which an inspection probe sensor assembly is fixed. However, use of a foam material can present various challenges, such as lacking mechanical durability, snagging as the probe is translated in contact with a surface, or presenting difficulties with respect to replacement.

The present inventors have recognized, among other things, that a flexible cushion structure can be used, such as to address one or more challenges mentioned above. The flexible cushion structure can be fabricated from a flexible polymer material and can include internal structure such as one or more ribs to provide structural integrity with specified compliance characteristics. As shown and described herein, various flexible cushion configurations can be used to inhibit or restrict rotation or compression in specified directions while facilitating conforming of an active surface of a probe assembly to an object under test. A compliance or conversely, stiffness (e.g., a degree of resistance to deformation or compression) can be uniform or non-uniform along an axis or a surface of the flexible cushion, according to various examples.

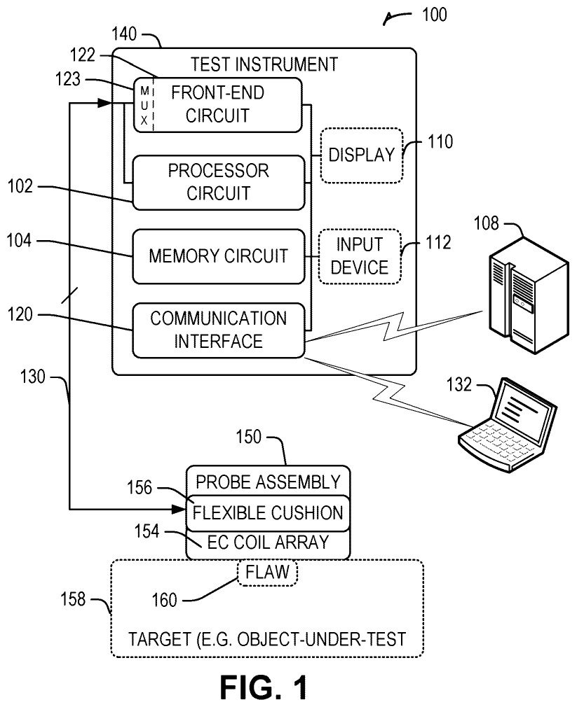

FIG. 1 illustrates generally an example comprising a non-destructive inspection system 100, such as can be used to perform at least a portion one or more techniques as shown and described herein, or can use apparatus as shown and described elsewhere in this document. The non-destructive inspection system 100 can include a test instrument 140, such as a hand-held or portable assembly. The test instrument 140 can be electrically coupled to a probe assembly 150, such as using a multi-conductor interconnect 130. The probe assembly 150 can include one or more sensors, such as an eddy current coil array 154 (ECA). The EC coils are electromagnetically coupled with a target 158 (e.g., a test specimen or “object-under-test”) and the system 100 can be used to detect a flaw 160 using one or more techniques shown and described in this document. The ECA 154 can be a four-coil planar cross-wound sensor (CWS) or an array of such sensors, or the ECA 154 can have another configuration, such as a one-dimensional array, or a two-dimensional array configuration, as illustrative examples. The ECA 154 can be flexible or can otherwise follow a linear or curved contour or can include an array of elements extending in multiple axes. Element size and pitch can be varied according to the inspection application. As shown and described elsewhere herein, a flexible cushion 156 can support the EC coil array 154, such as to assist in conforming the EC coil array 154 to a surface of the target 158.

A modular probe assembly 150 configuration can be used, such as to allow a test instrument 140 to be used with various different probe assemblies. The test instrument 140 can include digital and analog circuitry, such as a front-end circuit 122 including one or more transmit signal chains (forming a transmitter circuit), receive signal chains (forming a receiver circuit), or switching circuitry (e.g., a multiplexer circuit 123). The transmit signal chain can include amplifier and filter circuitry, such as to provide an alternating current (AC) excitation signal for delivery through an interconnect 130 to a probe assembly 150.

While FIG. 1 shows a single probe assembly 150 and a single ECA 154, other configurations can be used, such as multiple probe assemblies connected to a single test instrument 140, or multiple arrays 154 used with a single probe assembly 150. Similarly, a test protocol can be performed using coordination between multiple test instruments 140, such as in response to an overall test scheme established from a respective test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The front-end circuit 122 can be coupled to and controlled by one or more processor circuits, such as a processor circuit 102 included as a portion of the test instrument 140. The processor circuit can be coupled to a memory circuit 104, such as to execute instructions that cause the test instrument 140 to perform one or more of EC acquisition, processing, or storage of data relating to an EC inspection. The test instrument 140 can be communicatively coupled to other portions of the system 100, such as using a wired or wireless communication interface 120.

Performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system, such as using physical or virtualized processing resources), such as in response to a request from the test instrument 140. The test instrument 140 can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

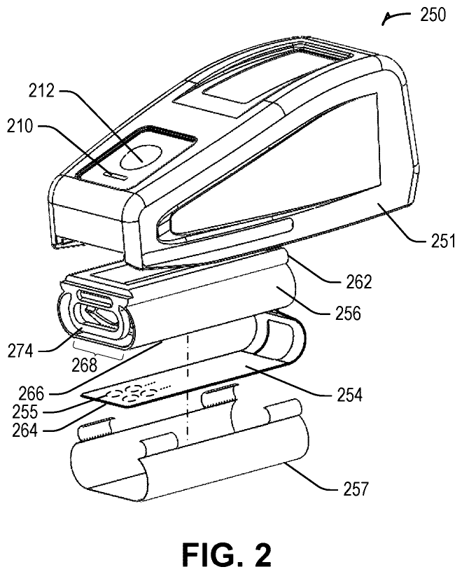

FIG. 2 is a diagram illustrating an exploded view of a non-destructive inspection probe assembly 250 comprising various elements, including a flexible cushion 256 and a flexible sensor assembly 254. Generally, as mentioned above, the flexible sensor assembly 254 comprises one or more eddy current sensor elements 255, such as planar winding structures. An active surface 264 of the flexible sensor assembly 254 can be oriented to face outward from the flexible sensor assembly 254, such as to be placed in proximity to an object under test. For example, one or more cover layers, such as a polyolefin layer 257, can be placed over the flexible sensor assembly 254 and at least a portion of the surface of the flexible cushion 256. This can help to retain the flexible sensor assembly 254 against the flexible cushion 256 and to avoid snagging or binding of the edges of the flexible sensor assembly 254 as the probe assembly 250 is translated or scanned across a surface of an object under test.

A wear plate, such as comprising polytetrafluoroethylene (PTFE), can be used to inhibit wear of the polyolefin layer 257 or other elements such as the flexible sensor assembly 254 or flexible cushion 256. As shown in FIG. 2, the flexible cushion 256 can include or define a recessed region or channel 268, such as to receive a planar sensor region of the flexible sensor assembly 254, such as avoiding protrusion of the flexible sensor assembly 254 outward from the bottom of the flexible cushion 256 (e.g., establishing a flush or near-flush configuration) with the flexible sensor assembly residing in the channel 268.

The flexible cushion 256 can include other features, such as a protruding ridge or rail 262 that mates with a corresponding portion of a housing 251, at least in part to mate the flexible cushion 256 with the housing 251. For example, a semicircular protrusion can mate with a corresponding semi-circular cavity included as a portion of the housing 251. As shown and described in other examples, the flexible cushion 256 can include other features such as internal ribs or a stop 274. The stop 274 can inhibit compression of the flexible cushion 256 beyond a specified limit, such as by mechanical interference of the stop 274 with a surface 266 of the flexible cushion 256. The non-destructive inspection probe assembly 250 can include one or more user interface features, such as an input (e.g., a button 212) and a display such as an indicator 210. For example, when the probe assembly 250 is placed in a position to commence a scan, the input button 212 can be actuated and the indicator 210 can indicate a status (e.g., by illuminating or changing color).

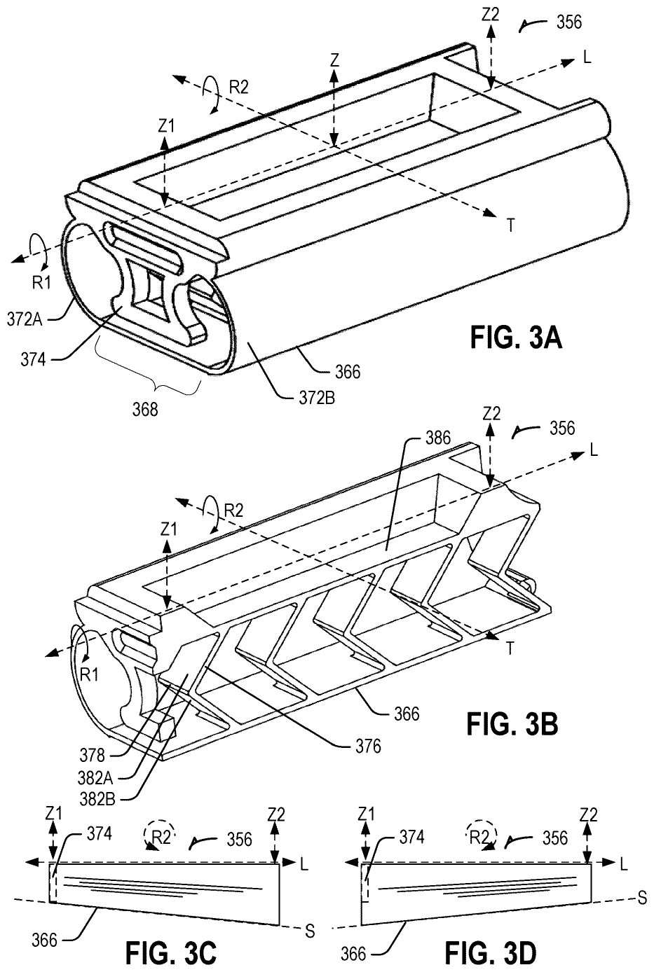

FIG. 3A illustrates generally an example comprising a flexible cushion 356, such as similar to the flexible cushion 256 of FIG. 2. FIG. 3B illustrates a cut-away view of the flexible cushion 356 of FIG. 3A. Referring to FIG. 3A and FIG. 3B, the flexible cushion 356 can be compliant, such as comprising a flexible polymer material. For example, an elastomeric polymer can be used that can be compliant. When a surface 366 of the flexible cushion 356 is placed upon a surface of an object under test, the flexible cushion 356 can deform to conform the surface 366 to the surface of the object under test. Such deformation or compliance can be controlled, such as where the flexible cushion 356 allows compression in the “Z” axis orthogonal to locations along a centerline defined by a longitudinal axis, “L,” but rotation, “R1” about the longitudinal axis, L, is inhibited (e.g., in a “roll” direction), or rotation, “R2” about a transverse axis, “T” is inhibited (e.g., in a “pitch” direction), or both. In this manner, the flexible cushion resist deformation in one (or more degrees) of freedom, such as R1 or R2, or both, and allows deformation in another degree of freedom (e.g., in Z direction). Such deformation need not be uniform. For example, deformation may be greater or lesser in the Z direction at the location labeled Z1, as compared to another location labeled Z2, depending on a shape of a surface being inspected, as shown and discussed below in relation to FIG. 3C and FIG. 3D. The flexible cushion 356 can include or define a recessed region or channel 368, such as to receive a planar sensor region of the flexible sensor assembly.

Referring to FIG. 3A and FIG. 3B, deformation of the flexible cushion 356 in the Z direction can be facilitated by a first web region 372A and a second web region 372B. Such web regions can extend outward laterally in the transverse direction when the flexible cushion 356 is compressed in the Z direction or inward when the flexible cushion is elongated in the Z direction. A stop 374 can inhibit compression in the Z direction beyond a specified displacement. Resistance to rotation in the degrees of freedom R1 and R2 can be controlled such as using rib structures. For example, one or more ribs such as a rib 376 can be included, such as extending between interior-facing surfaces 366 and 386 as shown in FIG. 3B. The ribs can be linear, such as comprising a single planar or curved surface, or can include multiple segments. Generally, a combination of the first web region 372A, the second web region 372B, and one or more rib structures can provide a structure that resists deformation of the flexible cushion 356 in a first degree of freedom relative to an orthogonal second degree of freedom.

As shown in FIG. 3B and other examples, the rib 376 comprises two planar segments 382A and 382B comprising edges that intersect to define a vertex 378, the vertex extending parallel to the transverse direction, T. In this manner, in the configuration shown in FIG. 3B and elsewhere, rib 376 configuration will allow Z-axis displacement by folding or elongation, but such a structure will resist translation of the upper surface 386 relative to the lower surface 366 in the transverse direction, T, and the rib 376 configuration will resist rotation, R1, about the longitudinal axis, L, as an illustrative example. The orientation and shape of the rib 376 shown in FIG. 3B is illustrative, and other configurations can be used.

To allow the flexible cushion 356 active surface 366 to conform to object surfaces being inspected, deformation of the flexible cushion 356 need not be uniform. For example, FIG. 3C and FIG. 3D illustrate respective examples of side views of non-uniform compression of the flexible cushion 356 along the length of the flexible cushion 356, such as to conform to a surface, “S,” of an object under test that is angled with respect to a surface 366 of the flexible cushion 356. For example, in FIG. 3C, location Z1 is compressed until the stop 374 abuts the bottom wall of the flexible cushion 356, and location Z2 is less compressed or uncompressed. By contrast, in FIG. 3D, location Z1 is less or uncompressed relative to location Z2. As discussed below, a compliance (e.g., a resistance to deformation) of the flexible cushion 356 need not be uniform along a length or across an area of the flexible cushion 356.

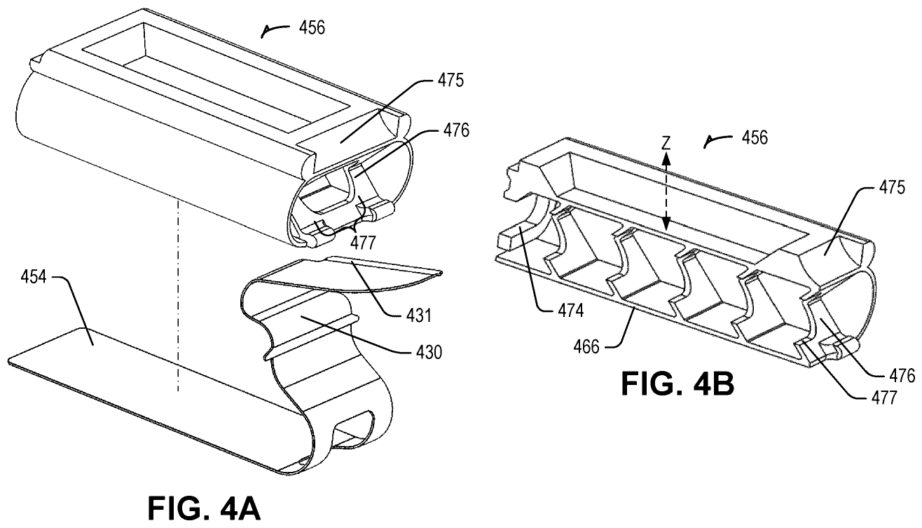

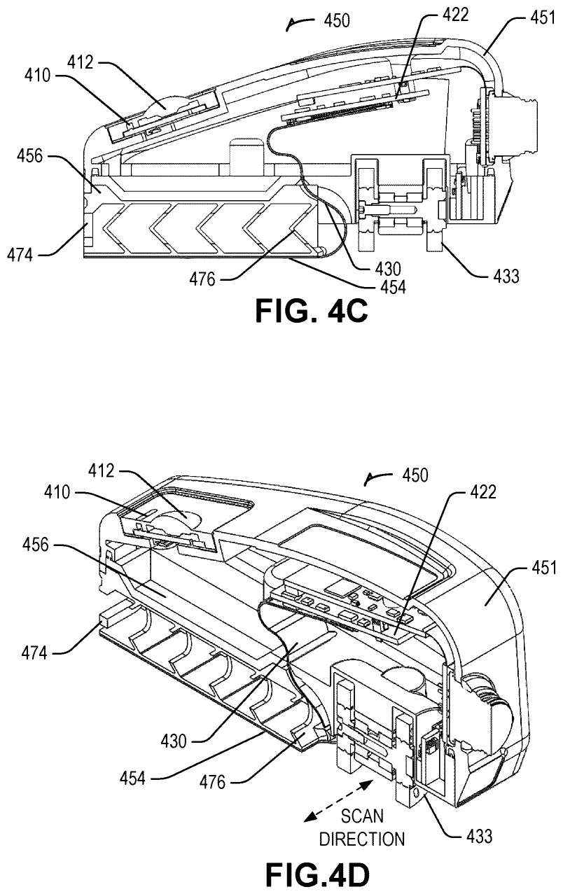

FIG. 4A is a diagram illustrating an exploded view of a flexible cushion 456 and a flexible sensor assembly 454 that can form a portion of a non-destructive inspection probe assembly. The configuration of the flexible sensor assembly 454 shown in FIG. 4A and elsewhere, can include a flexible interconnection 430, such as polyimide flex circuit having one or more metallization layers. The metallization layers can also be used to define one or more eddy current sensor elements included in the flexible sensor assembly 454. The flexible interconnection 430 can include or can terminate in connector region 431, such as an edge connector formed using the flexible printed circuit board (PCB) assembly. The flexible interconnection can include features such as folds, curves, or bends to permit the flexible sensor assembly 454 to translate or flex to conform to a surface of an object under test as the flexible cushion 456 is deformed. The flexible cushion 456 can define one or more features such as an area 475 to permit deformation and displacement of the flexible interconnection 430 without mechanical interference with the flexible cushion 456 in response to deformation of the flexible cushion. FIG. 4B illustrates a cut-away view of the flexible cushion 456 of FIG. 4A.

As discussed elsewhere, one or more rib structures can be included to control the deformability of the flexible cushion 456. A rib can include a slot, aperture, or gap, such as make the rib structure more compliant (e.g., less rigid). As shown in FIG. 4B, a rib 476 can define an aperture 477, such as to make the flexible cushion 456 more compliant in the Z direction along the center-line (with the center-line defined as the cut-line for the cut-away view of FIG. 4B), as compared to solid ribs as shown in FIG. 3B. FIG. 4A and FIG. 4B also show a stop 474, which can inhibit Z axis deformation. The stop 474 can also include a slot or aperture, such that inhibition of deformation does not entirely preclude further deformation, but that such deformation requires more force. In this manner, an active surface 466, housing the sensor assembly 454, can more easily be kept in contact with an irregular surface of an object under test using slightly more than a minimum force to deform the flexible cushion 456. This behavior may be useful for providing force feedback to a user holding a probe assembly comprising the flexible cushion 456 or for applications where an automated system such as a robotic manipulator or other scanner places a probe assembly comprising the flexible cushion 456 upon an object under test.

FIG. 4C illustrates a side cut-away view of a non-destructive inspection probe assembly 450 that can include the flexible cushion 456 and flexible sensor assembly 454 shown in FIG. 4A. FIG. 4D illustrates an isometric cut-away view of a non-destructive inspection probe assembly 450 that can include the flexible cushion 456 and flexible sensor assembly shown in FIG. 4A. Referring to FIG. 4C and FIG. 4D, as discussed above in relation to FIG. 4A, the flexible sensor assembly 454 can be coupled to or can include a flexible interconnection 430 such as to electrically coupled the flexible sensor assembly 454 with electronic circuitry 422 located within a housing 451. The non-destructive inspection probe assembly 450 can include a single-axis or multi-axis encoder, such as a single-axis encoder 433 including one or more wheels. For example, the non-destructive inspection probe assembly 450 can be configured to perform scanning in a lateral direction along which the wheels of the single-axis encoder 433 rotate. A plane of the bottom surface of the wheels can be offset relative to a plane of the flexible cushion 456 such that the flexible cushion 456 is compressed before the wheels of the single-axis encoder 433 engage a surface of an object under test to which the flexible sensor assembly 454 is applied. As discussed above, the non-destructive inspection probe assembly 450 can include other features such as an input (e.g., button 412), and an indicator 410 or other visual display element.

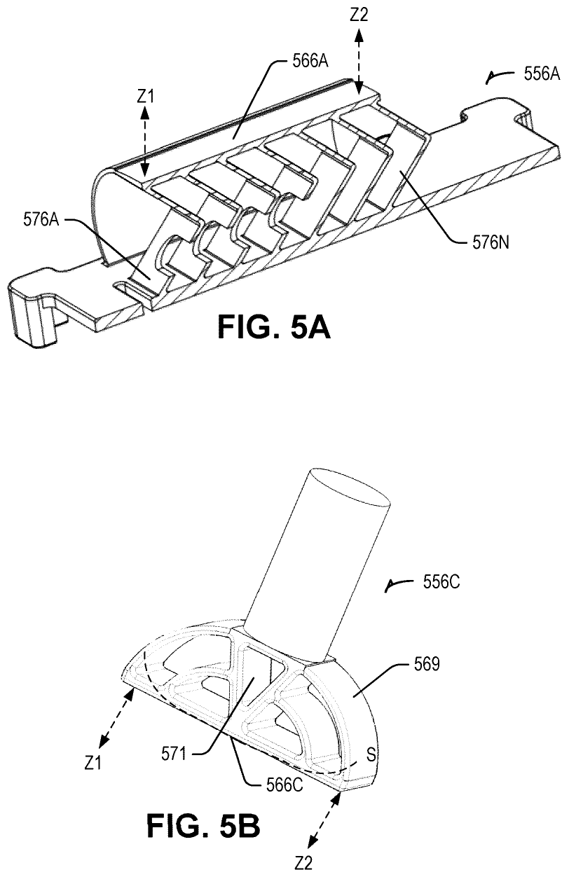

FIG. 5A illustrates generally another example comprising an isometric cut-away view of a flexible cushion 556A that can have a non-uniform compliance along at least one axis. By contrast with examples discussed above, respective rib structures shown in the example of FIG. 5A can have a different configuration from each other. For example, as shown, a rib 576A can define a slot, aperture, or gap to establish a greater degree of center-line Z-axis compliance at location Z1 along a surface 566A, and a rib 576N can omit such a slot, aperture, or gap, to establish a relatively lesser degree of center-line Z-axis compliance at location Z2, relative to location Z1. The configuration shown in FIG. 5A is illustratively, and the orientation shown can be reversed or otherwise modified.

FIG. 5B illustrates generally yet another example comprising an isometric view of a flexible cushion 556C that can have a non-uniform compliance along at least one axis. In the example of FIG. 5B, an outer web 569 can permit Z-axis displacement of a surface 566C at location Z2, and a symmetrically-located structure can permit Z-axis displacement of the surface 566C at location Z1. A stiffener 571 can inhibit displacement in the central region of the surface 566C, such as to allow the flexible cushion 556C to conform a sensor assembly located at the surface 566C to a concave surface, “S,” being inspected.

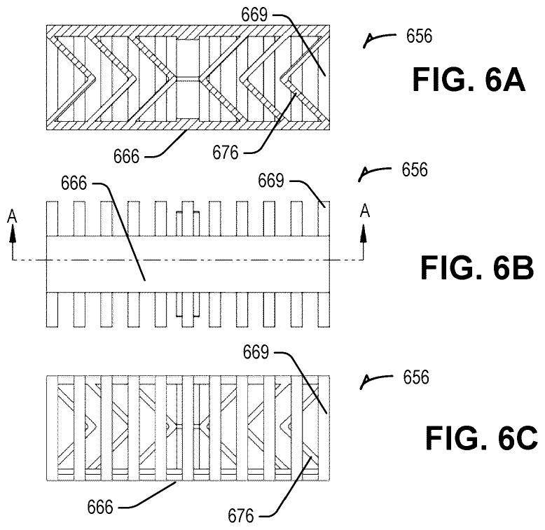

FIG. 6A, FIG. 6B, and FIG. 6C illustrate different views of yet another example comprising a flexible cushion 656, having inner and outer rib arrangements. FIG. 6A shows a section view as indicated in FIG. 6B, where FIG. 6B shows a bottom view looking at an active surface 666 of the flexible cushion 656, and FIG. 6C shows a side view of the flexible cushion 656. In the example of the flexible cushion 656, outer curved ribs such as a rib 669 can be included, instead of or in addition to one or more interior rib structures such as a rib 676. Such a configuration can use outer ribs, inner ribs, or both, to control a degree of compliance of the flexible cushion. Such a configuration can also use less material than other configurations using a solid outer web.

The various flexible cushion configurations shown in this document can be manufactured using a variety of different approaches. Simpler configurations can be molded, stamped, or otherwise formed. Profiles having inner structure such as ribs as shown herein can be fabricated using an additive manufacturing approach or other approaches. For example, an elastomer such as silicone or a thermoplastic elastomer can be used. Examples of thermoplastic elastomers include thermoplastic polyurethane material (TPU) or a thermoplastic polyamide (TPA) material. Such materials can withstand transient exposure to hydrocarbon-based fluids or contaminants such as hydraulic fluid, such as where the flexible cushion is used for ECA inspection in aerospace, maritime, chemical process, oil or pipeline services, or other applications.

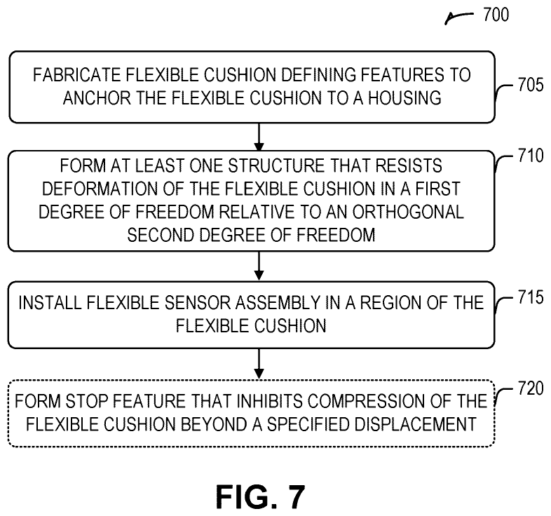

As an illustrative example, FIG. 7 illustrates generally a technique 700, such as a method of fabrication, to provide a flexible cushion, such as associated with an inspection probe assembly. For example, at 705, a flexible cushion can be fabricated (such as three-dimensionally printed using an additive manufacturing process). The flexible cushion can define one or more features to anchor the flexible cushion to a housing of a non-destructive probe assembly. At 710, the fabrication can include forming at least one structure that resists deformation of the flexible cushion in a first degree of freedom relative to an orthogonal second degree of freedom. For example, web or rib structures such as shown and described elsewhere herein can be formed at 710, such as using the additive manufacturing process.

At 715, a flexible sensor assembly, such as a flexible ECA sensor, can be installed in a region of the flexible cushion. For example, a channel or other region of the flexible cushion can support the flexible sensor assembly. The flexible sensor assembly can be adhered to the flexible cushion using an adhesive layer, such as a pressure-sensitive adhesive or the flexible sensor assembly can be retained by a cover layer, such as comprising a polyolefin material that is affixed to the flexible sensor assembly and at least a portion of the flexible cushion. At 720, a stop feature can be formed that inhibits compression of the flexible cushion beyond a specified displacement. Other fabrication techniques can include use of different materials for different portions of the flexible cushion such as stiffeners or the like, or entirely different approaches such as single shot or multi-shot molding, insert molding, or the like. Accordingly, the example of FIG. 7 and other examples described in this document are merely illustrative.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A non-destructive inspection probe assembly, comprising:
a housing;
a flexible cushion coupled to the housing; and
a flexible sensor assembly anchored to the flexible cushion;
wherein the flexible cushion comprises at least one rib structure extending between interior-facing surfaces of the flexible cushion that resists deformation of the flexible cushion in a first degree of freedom relative to an orthogonal second degree of freedom.

2. The non-destructive inspection probe assembly of claim 1, wherein the first degree of freedom comprises rotation in a pitch direction about a transverse axis of the flexible cushion.

3. The non-destructive inspection probe assembly of claim 1, wherein the second degree of freedom comprises rotation in a roll direction about a longitudinal axis of the flexible cushion.

4. The non-destructive inspection probe assembly of claim 1, wherein the flexible cushion permits deformation in a Z direction that is orthogonal to a plane defining an active surface of the flexible cushion.

5. (canceled)

6. The non-destructive inspection probe assembly of claim 1, wherein the at least one rib structure is angled, defined by two planar segments comprising edges that intersect to define a vertex.

7. (canceled)

8. The non-destructive inspection probe assembly of claim 1, wherein a surface of the at least one rib structure defines a slot, aperture, or gap.

9. The non-destructive inspection probe assembly of claim 1, comprises a stop feature that inhibits compression of the flexible cushion beyond a specified displacement.

10. The non-destructive inspection probe assembly of claim 1, wherein the flexible sensor assembly comprises a flexible printed circuit board (PCB) assembly including a flexible interconnection between an active surface of the flexible sensor assembly anchored to the flexible cushion and circuitry within the housing.

11-13. (canceled)

14. The non-destructive inspection probe assembly of any of claim 1, wherein the flexible sensor assembly comprises an eddy current array (ECA) sensor.

15-16. (canceled)

17. A method for fabrication of a non-destructive inspection probe, the method comprising:
additively manufacturing a flexible cushion defining features to anchor the flexible cushion to a housing, the additively manufacturing the flexible cushion comprising forming at least one rib structure that resists deformation of the flexible cushion in a first degree of freedom relative to an orthogonal second degree of freedom; and
installing a flexible sensor assembly in a region of the flexible cushion to orient an active surface of the flexible sensor assembly outward from a surface of the flexible cushion.

18. The method of claim 17, wherein the at least one rib structure extends between interior-facing surfaces of the flexible cushion.

19. The method of claim 17, wherein the at least one rib structure is angled, defined by two planar segments comprising edges that intersect to define a vertex.

20. (canceled)

21. The method of claim 17, wherein a surface of the at least one rib structure defines a slot, aperture, or gap.

22. The method of claim 17, wherein the additively manufacturing comprises forming a stop feature that inhibits compression of the flexible cushion beyond a specified displacement.

23. (canceled)

24. The method of claim 17, wherein the installing comprises placing the flexible sensor assembly in a channel defined by the flexible cushion to inhibit protrusion of the active surface of the flexible sensor assembly outward from the flexible cushion.

25. (canceled)

26. The method of claim 17, wherein the flexible sensor assembly comprises an eddy current array (ECA) sensor.

27. A flexible cushion for a non-destructive inspection probe, the flexible cushion comprising a flexible polymer material defining:
at least one rib structure that resists deformation of the flexible cushion in a first degree of freedom relative to an orthogonal second degree of freedom; and
a region for installation of a flexible sensor assembly to orient an active surface of the flexible sensor assembly outward from a surface of the flexible cushion.

28. The flexible cushion of claim 27, wherein the at least one rib structure extends between interior-facing surfaces of the flexible cushion.

29. The flexible cushion of claim 28, comprising multiple rib structures extending between interior-facing surfaces of the flexible cushion;
wherein at least two rib structures amongst the multiple rib structures comprise configurations that differ from each other to provide different degrees of compliance from each other.

30. The flexible cushion of claim 27, wherein the flexible polymer material is an additive manufacturing material.
